(19) United States
(12) Patent Application Publication
(10) Pub. No.: US 2014/0296072 A1
(43) Pub. Date: Oct. 2, 2014

(54) Pesticide Preparations

(71) Applicants: Andreas Wacker, Mannheim (DE); Carsten Cohrs, Frankfurt (DE)

(72) Inventors: Andreas Wacker, Mannheim (DE); Carsten Cohrs, Frankfurt (DE)

(73) Assignee: CLARIANT FINANCE (BVI) LIMITED, Tortola (VG)

(21) Appl. No.: 14/238,061

(22) PCT Filed: Aug. 16, 2012
(86) PCT No.: PCT/EP2012/003483

§ 371 Date: Apr. 1, 2014

(30) Foreign Application Priority Data
Aug. 20, 2011 (DE) 10 2011 111 152.6

(51) Int. Cl. A01N 25/30; A01N 57/20

(52) U.S. Cl. CPC A01N 25/30; A01N 57/20
USPC 504/206

(57) ABSTRACT

The invention relates to compositions containing a) one or more water-soluble pesticides, b) one or more quarternary ammonium compounds of the formula (I), R¹R²R³N³⁰—(CₘH₂ₘO)ₚH X⁻ (I), in which R¹ is a linear or branched alkyl group with 6 to 10 carbon atoms, R² and R³ can be the same or different and are each independently of each other an alkyl group with 1 to 3 carbon atoms, m is 2 or 3, p is a number from 1 to 5, and X is chlorine, and c) water.

The invention relates to aqueous, low-foam and storage-stable compositions which comprise pesticides and quaternary ammonium compounds.

Pesticides (above all fungicides, herbicides and insecticides) are chemical or natural substances which penetrate into plant cells, plant tissue or parasitic organisms in or on the plant and damage and/or destroy them, Herbicides account for most of the pesticides. Pesticides are usually employed in the form of preparations (formulations); frequently these preparations are water-based,

Water-soluble herbicides such as, for example, the water-soluble salts of glyphosate (N-phosphonomethyl-glycin) play an important role. Glyphosates, being highly environmentally compatible and at the same time highly active and broadly employable herbicides, are employed in agriculture in large amounts. They are preferably applied as alkali metal salt, ammonium salt, monoalkyl- or dialkylammonium salt, mono-, di- or triethanolammonium salt, alkylsulfonium salt or afkylphosphonium salt and in the form of mixtures of these salts, in most cases as aqueous formulations, where they act on the plant's transport system and destroy the former.

The biological activity of a pesticide can be determined by reference to the plant growth or the damage caused to the plants by the action of the active substance on the leaf or via the roots as a function of the exposure time and the exposure concentration.

A general problem is that only a fraction of the active substance displays the desired activity. The vast majority is lost without being utilized, due to the fact that the active substance, upon application of the spray mixture, does not reach the plant's leaves or roots and, unused, seeps into the soil, is washed off by rain or is not taken up by the plant.

This ecological and economical disadvantage can be reduced by adding adjuvants to pesticide formulations. These adjuvants can, for example, reduce spray drift, improve the wetting of the plant or ensure that the active substance adheres longer to the plant surface, or is taken up better. The nature and the amount of the adjuvants used have a decisive effect on the activity of the formulation, in particular in the case of water-soluble pesticides, such as, for example, in the case of glyphosate.

The adjuvants which are by far most frequently used in glyphosate formulations are fatty amine ethoxylates, mostly tallow fatty amine ethoxylates. However, these compounds must be classified as not acceptable due to their toxic and ecotoxicological properties, such as the potent irritant effect on eyes or the toxicity on aquatic organisms, and are increasingly replaced by adjuvants which have a better toxicological and environmental profile,

It is known from the literature that various quaternary ammonium compounds are suitable in principle as adjuvants for glyphosate formulations,

EP 441 764 describes glyphosate compositions comprising certain ethoxylated/propoxylated quaternary di- or trialkylammonium compounds.

WO 97/36489 discloses the use of a combination of certain alkyldimethylamine oxides with tetraalkylammoniurn compounds as glyphosate adjuvant.

WO 97/36494 describes glyphosate formulations which may comprise various mono- or di-fatty-alkyl(hydroxyalkyl)alkylammonium halides, where the fatty alkyl radical consists of 10 to 18 carbon atoms.

WO 2004/107861 discloses the combination of a series of quaternary fatty alkylammonium compounds and anionic surfactants where the mixture of the two species of surface-active substances results in better wetting (low surface tension).

WO 2010/020599 discloses thickened glyphosate formulations in which, again, certain quaternary fatty alkylammoniurn compounds are employed as adjuvants.

A disadvantage when using the known quaternary ammonium compounds in aqueous pesticide preparations is frequently that they do not meet the current requirements in respect of toxicological and ecotoxicological acceptability. These compounds are labeled as being an environmental hazard or an irritant, and some of them are employed specifically as biocides. Moreover, they tend to produce large amounts of foam, which results in great problems when used in plant protection formulations.

The demands made of adjuvants in aqueous pesticide preparations have grown increasingly over the years. What is demanded is not only high biological activity and acceptability (both from the user's point of view and from an environmental angle), but also, increasingly, further advantageous technical properties in use. The adjuvants should allow the highest possible load of the formulation with the active substance while having to be compatible with a variety of active substances. The formulations must be storage-stable and have as low a viscosity as possible so as to ensure simpler handling and to facilitate as complete as possible an emptying of the containers. Also demanded are good miscibility and rapid dissolution (even in cold water) when making up the spray mixture, What is of particular additional importance is a low tendency to foam since otherwise undesired foam development right up to overflowing of the tank with foam may result readily when the formulation is diluted with water.

It was an object to provide novel highly-active aqueous pesticide preparations which meet the abovementioned demands and which are distinguished in particular by properties which are advantageous in use, above all a low tendency to foam, and which are advantageous from the toxicological and ecological point of view.

Surprisingly, the object is achieved by compositions comprising
a) one or more water-soluble pesticides,
b) one or more quaternary ammonium compounds of the formula (I)

R¹R²R³N⁺—(CₘH₂ₘO)ₚH X⁻ (I)

wherein R¹ is a linear or branched alkyl group having 6 to 10 carbon atoms, R² and R³ may be identical or different and in each case independently of one another are an alkyl group having 1 to 3 carbon atoms, m is 2 or 3, p is a number from 1 to 5 and X is chlorine, and
c) water.

Accordingly, subject-matter of the invention is compositions comprising
a) one or more water-soluble pesticides,
b) one or more quaternary ammonium compounds of the formula (I)

R¹R²R³N⁺—(CₘH₂ₘO)ₚH X⁻ (I)

wherein R¹ is a linear or branched alkyl group having 6 to 10 carbon atoms, R² and R³ may be identical or different and in each case independently of one another are an alkyl group having 1 to 3 carbon atoms, m is 2 or 3, p is a number from 1 to 5 and X is chlorine, and
c) water.

Individual quaternary ammonium compounds of the formula (I) may, in the event that they comprise a plurality of structural units of the formula —(CₘH₂ₘO)—, also include a variety of structural units of the formula —(CₘH₂ₘO)—, i.e. not only structural units of the formula —(C₂H₄O)—, but also structural units of the formula —(C₃H₆O)—.

The quaternary ammonium compounds of the formula (I) are suitable as adjuvants in the compositions according to the invention for improving the biological activity of herbicides, insecticides, fungicides, acaricides, bactericides, molluscicides, nematicides and rodenticides.

By using the quaternary ammonium compounds of the formula (I), it is now possible to prepare compositions according to the invention which are storage-stable and which are distinguished by advantageous properties in use, such as a high and flexible active substance load, low viscosity and low tendency to foam, as well as toxicological and ecotoxicological acceptability.

For the purposes of the invention, water-soluble pesticides are understood as meaning pesticides which have solubility of more than 10 g/l and preferably more than 50 g/l water at room temperature (25° C.).

Preferred water-soluble pesticides are the water-soluble salts of acifluorfen, aminopyralid, amitrol, asulam, benazolin, bentazone, bialaphos, bispyribac, bromacil, bromoxynil, bicyclopryon, chloramben, olopyralid, 2,4-D, 2,4-DB, dicamba, dichlorprop, difenzoquat, diquat, endothal, fenoxaprop, flamprop, flumiclorac, fluoroglycofen, fomesafen, fosamine, glufosinate, glyphosate, imizameth, imazamethabenz, imazarmox, imazapic, imazapyr, imazaquin, imazethapyr, MCPA, MCPB, mecoprop, octanoic acid, paraquat, pelargonic acid, picloram, quizalofop, 2,3,6-TBA and triclopyr.

Especially preferred are water-soluble herbicides, and particularly preferred are the water-soluble salts of 2,4-D, bentazone, dicamba, fomesafen, glyphosate, glufosinate, MCPA and paraquat. Extraordinarily preferred are the water-soluble salts of glyphosate.

Preferred among the water-soluble salts of glyphosate, in turn, are the alkali metal salts, ammonium salts, monoalkyl- or dialkylarnmonium salts, mono-, di- or triethanolammonium salts, alkylsulfonium salts, alkylphosphonium salts, sulfonylamine salts or aminoguanidine salts and mixtures of these salts. In this context, “monoalkylammonium” especially preferably means “isopropylammonium”, Especially preferred among the alkali metal salts is the potassium salt.

The one or more quaternary ammonium compounds of the formula (I) can be employed for the preparation of the compositions according to the invention, in particular in the form of aqueous solutions. The active content of the one or more quaternary ammonium compounds of the formula (I) in these aqueous solutions is preferably 20 to 60% by weight,

In the one or more quaternary ammonium compounds of the formula (I), the radial R¹ is preferably a linear or branched alkyl group having 8 to 10 carbon atoms. The radials R² and R³ are preferably identical and are in each case a methyl or ethyl group. The alkoxy groups are ethoxy or propoxy groups (m=2 or 3), p is preferably 1 or 2, and X is chlorine.

Especially preferred are quaternary ammonium compounds of the formula (I) in which the radical R¹ is a linear or branched alkyl group having 8 to 10 carbon atoms, R² and R³ are identical and are in each case a methyl group, m is 2, p is 1 and X is chlorine.

Particularly preferred are quaternary ammonium compounds of the formula (I) in which R¹ Is a linear or branched alkyl group having 8 carbon atoms, R² and R³ are, identical and are in each case a methyl group, m is 2, p is I and X is chlorine.

Also especially preferred are quaternary ammonium compounds of the formula (I) in which R¹ is a linear or branched alkyl group having 10 carbon atoms, R² and R³ are identical and are in each case a methyl group, m is 2, p is 1and X is chlorine.

In a further especially preferred embodiment of the invention, the compositions according to the invention comprise one or more quaternary ammonium compounds of the formula (I) in which R¹ is a linear or branched alkyl group having 6 to 10 and preferably 8 to 10 carbon atoms and wherein the amount of ammonium compounds of the formula (I) in which R¹ is a linear or branched alkyl group having 6 to 9, preferably 6 to 8 and particularly preferably 8 carbon atoms, is from 5 to 100% by weight, preferably from 7 to 100% by weight and particularly preferably from 9 to 100% by weight, and wherein the abovementioned amounts are based in each case on the total amount of quaternary ammonium compounds of the formula (I) in the compositions according to the invention (hereinbelow “embodiment A of the invention”),

In an embodiment of the invention which, in turn, is preferred among embodiment A of the invention, the compositions according to the invention comprise a plurality of quaternary ammonium compounds of the formula (I), wherein the radicals R¹ are a linear or branched alkyl group having 8 carbon atoms in 5 to 20% weight, preferably in 7 to 15% by weight and especially preferably in 9 to 13% by weight of the ammonium compounds of the formula (I) and the radicals R¹ are a linear or branched alkyl group having 10 carbon atoms in 80 to 95% by weight, preferably in 85 to 93% by weight and especially preferably in 87 to 91% by weight of the ammonium compounds of the formula (I). The abovementioned amounts are based in each case on the total amount of quaternary ammonium compounds of the formula (I) in the compositions according to the invention. In an embodiment of the invention which, in turn, is preferred among these, the radical R¹ of the quaternary ammonium compounds of the formula (I) in the compositions according to the invention is selected from among linear or branched alkyl groups having 8 and 10 carbon atoms.

In a further embodiment of the invention which, in turn, is preferred among embodiment A of the invention, the compositions according to the invention comprise a plurality of quaternary ammonium compounds of the formula (I), wherein the radicals R¹ are a linear or branched alkyl group having 8 carbon atoms in 30 to 70% by weight, preferably in 35 to 65% by weight and especially preferably in 40 to 60% by weight of the ammonium compounds of the formula (I), and the radicals R¹ are a linear or branched alkyl group having 10 carbon atoms in 30 to 70% by weight, preferably in 35 to 65% by weight and especially preferably in 40 to 60% by weight of the ammonium compounds of the formula (I). The abovementioned amounts are based in each case on the total amount of quaternary ammonium compounds of the formula (I) in the compositions according to the invention.-in an embodiment of the invention which, in turn, is preferred among these, the radical R¹ of the quaternary ammonium compounds of the formula (I) present in the compositions according to the invention is selected from among linear and branched alkyl groups having 8 and 10 carbon atoms.

Both in the abovementioned embodiment A of the invention and in the likewise abovementioned embodiments of the invention which, in turn, are preferred among embodiment A of the invention, R² and R³ may be identical or different in the one or more quaternary ammonium compounds of the formula (I) and are in each case independently an alkyl group having 1 to 3 carbon atoms and are preferably identical and are in each case a methyl or ethyl group and especially preferably a methyl group, m is 2 or 3 and preferably 2 and p is a number of from 1 to 5, preferably 1 or 2 and especially preferably 1 and X is chlorine,

The alkyl groups R¹ of the one or more quaternary ammonium compounds of the formula (I) are preferably linear.

In the event that the compositions according to the invention comprise one or more quaternary ammonium compounds R¹R²R³N³⁰—(CₘH₂ₘO)ₚH X⁻ in which R¹, R², R³, m and X have the meanings stated for the quaternary ammonium compounds of the formula (I), which differ, however, from the quaternary ammonium compounds of the formula (I) in that p* is a number greater than 0, but a different number than stated for p in the quaternary ammonium compounds of the formula (I) (these compounds are referred to hereinbelow as “quaternary ammonium compounds of the formula (I*)”) and for example p* is a number of from 6 to 50 or from 3 to 50 (in the event that p in preferred embodiments in formula (I) is 1 or 2) or from 2 to 50 in the event that p in preferred embodiments in formula (1) is 1), then the amount of the one or more quaternary ammonium compounds of the formula (I) in these compositions according to the invention and based on the total of the amounts of the one or more quaternary ammonium compounds of the formula (I) and of the one or more ammonium compounds of the formula (11 in these compositions according to the invention is preferably 30% by weight or greater, particularly preferably 50% by weight or greater, especially preferably 80% by weight or greater and extraordinarily preferably 95% by weight or greater. As already suggested, the preferred embodiments of the invention which have just been mentioned not only apply to the embodiments of the invention in which the compositions according to the invention comprise one or more quaternary ammonium compounds of the formula (1), wherein the meaning of p is given as “a number from 1 to 5”, but also to the embodiments of the invention in which the compositions according to the invention comprise one or more quaternary ammonium compounds of the formula (I) wherein the meaning of p is given as “1 or 2” or as “1”,

Using the above-described quaternary ammonium compounds of the formula (I), it is possible to prepare compositions according to the invention, in particular aqueous herbicide formulations, which have outstanding properties in use. In comparison with other quaternary ammonium compounds, the tendency to foam is markedly reduced.

Moreover, the toxicological and ecotoxicological properties of the compositions according to the Invention are considerably improved.

The preparation of the quaternary ammonium compounds of the formula (I) has been sufficiently previously described and known to a person skilled in the art,

When formulating aqueous pesticide compositions, it is an aim to load the composition with as high as possible a concentration of active substance. This reduces packaging, transport, storage and disposal costs. A contemporary adjuvant should therefore be capable of making possible stable highly-loaded pesticide compositions, known as “high-load formulations”. This is made possible with the quaternary ammonium compounds of the formula (I).

In a preferred embodiment of the invention, the amount of the one or more water-soluble pesticides of component a) in the compositions according to the invention is from 80 to 800 g/l, preferably from 200 to 700 g/l and particularly preferably from 300 to 650 g/l. These amounts relate to the entire composition according to the invention, and in the case of pesticides which are employed in the form of their water-soluble salts (such as usually for example glyphosate or 2,4-D), to the amount of free acid, known as the “acid equivalent” (a.e.).

In a further preferred embodiment of the invention, the amount of the one or more quaternary ammonium compounds of the formula (I) in the compositions according to the invention is from 28 to 250 g/l, preferably from 40 to 200 g/l and particularly preferably from 50 to 150 g/l. These amounts relate to the entire composition according to the invention.

Usually, the quaternary ammonium compounds of the formula (I) are employed in the form of aqueous solutions. For clarity, it should be mentioned here that the abovementioned amounts relate in this context to the active content of the quaternary ammonium compounds of the formula (I) in the aqueous solution and to the entire composition according to the invention.

An important criterion for the storage stability of aqueous pesticide compositions such as, for example, glyphosate and 2,4-D formulations, is their phase stability. In this context, what is known as the cloud point is a parameter for determining the phase stability. This is the temperature up to which an aqueous formulation can be warmed without phase separation taking place.

Before the cloud point is reached, the surfactants and the pesticide are present in defined concentrations in the aqueous formulation, in the form of a dear homogeneous solution. Upon warming to temperatures above the cloud point, the formulation which has previously been transparent, will first become cloudy, the surfactant separates from the solution, and phase separation occurs upon standing,

The cloud point of a composition is typically determined by warming the solution until it becomes cloudy. Thereafter, the stirred composition is left to cool while constantly monitoring the temperature, The temperature at which the cloudy solution returns to its clear state is documented as the reading for the cloud point,

At 25° C., the compositions according to the invention are preferably present as clear homogeneous solutions.

The compositions according to the invention are distinguished by a cloud point of preferably greater than 55° C., particularly preferably of greater than 70° C. and especially preferably of greater than 80° C.

Besides the one or more quaternary ammonium compounds of the formula (I), the compositions according to the invention may comprise one or more further adjuvants, which may, for example, be solvents, preservatives, wetting agents, other surface-active substances, low-temperature stabilizers or antifoams.

Suitable additional solvents in the compositions according to the invention are water-miscible solvents such as, for example, N-methylpyrrolidone, butyrolactone, lactic acid esters, esters of carbonic acid such as propylene carbonate, and mono- or polyhydric aliphatic alcohols such as mono- or polypropylene glycol, glycerol, mono- or polyethylene glycol.

Preservatives which may be employed are organic acids and their esters, for example ascorbic acid, ascorbyl palmitate, sorbate, benzoic acid, methyl and propyl 4-hydroxybenzoate, propionates, phenol, for example 2-phenyl phenate, 1,2-benzisothiazolin-3-one, formaldehyde, sulfurous acid and salts thereof.

Wetting agents which may be employed are alcohol alkoxylates or anionic sulfated or sulfonated compounds.

Low-temperature stabilizers may be all customary substances which can be employed for this purpose. Examples which may be mentioned are glycerol or (poly)glycols.

Suitable antifoams are fatty acid alkyl ester alkoxylates, organopolysiloxanes such as polydimethylsiloxanes and their mixtures with microfine, optionally silanized silica; perfluoroalkylphosphonates and -phosphinates, paraffins, waxes and microcrystalline waxes and their mixtures with silanized silica. Also advantageous are mixtures of different foam inhibitors, for example these of silicone oil, liquid paraffin and/or waxes.

In a further preferred embodiment of the invention, the compositions according to the invention comprise, besides the one or more quaternary ammonium compounds of the formula (I), one or more further adjuvants (II)

Especially preferred in this context are adjuvants (IIa) (IIf), which are traditionally employed in aqueous pesticide compositions such as, for example, in aqueous glyphosate formulations. The especially preferred adjuvants (IIa)-(IIf) are selected from the group consisting of:

(IIa) one or more fatty amine ethoxylates of the formula (IIa)

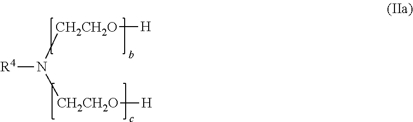

wherein R⁴ is a linear or branched, saturated or unsaturated hydrocarbon group, preferably an alkyl group, haying 8 to 22 carbon atoms, and b and c in each case independently of one another are numbers from 1 to 10,

(IIb) one or more ether amine ethoxylates of the formula (IIb)

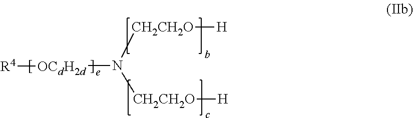

wherein R⁴ is a linear or branched, saturated or unsaturated hydrocarbon group, preferably an alkyl group, having 8 to 22 carbon atoms, d is 2 or 3, e is a number from 1 to 5 and b and c in each case independently of one another are numbers from 1 to 10,

(IIc) one or more betaines, amidoalkylbetaines of the formula (IIc)

R⁴—[CONH—(CH₂)ₙ]ₐN⁺R⁵R⁶—CH₂—COO⁻ (IIc)

wherein R⁴ is a linear or branched, saturated or unsaturated hydrocarbon group, preferably an alkyl group, having 8 to 22 carbon atoms, R⁵ and R⁶ in each case independently of one another are a methyl or ethyl group, n is a number from 1 to 5 and a is 0 or 1,

(IId) one or more amine oxides, amidoalkylamine oxides of the formula (IId)

R⁴—[CONH—(CH₂)ₙ]ₐN⁺R⁵R⁶—O⁻ (IId)

wherein R⁴ is a linear or branched, saturated or unsaturated hydrocarbon group, preferably an alkyl group, having 8 to 22 carbon atoms, R⁵ and R⁶ in each case independently of one another are a methyl or ethyl group, n is a number from 1 to 5 and a is 0 or 1,

(IIe) one or more polyglycosides of the formula (IIe)

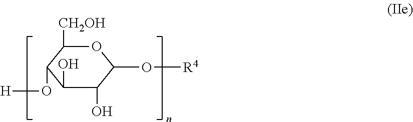

wherein R⁴ is a linear or branched, saturated or unsaturated hydrocarbon group, preferably an alkyl group, having 8 to 22 carbon atoms, and h is a number from 1 to 5, and

(IIf) one or more copolymers (IIf), which are obtainable by copolymerization of
i) glycerol,
ii) one or more dicarboxylic acids and
iii) one or more monocarboxylic acids R⁷—COOH, wherein R⁷ is (C₅-C₂₉)-alkyl, (C₇-C₂₉)-alkenyl, phenyl or naphthyl, and which comprise 19.9 to 99% by weight of component i), 0.1 to 30% by weight of component ii) and 0.9 to 80% by weight of component iii).

In the event that the individual etheramineethoxylates of the formula (IIb) comprise a plurality of structural units of the formula —(OC_{d}H_{2d})—, different structural units of the formula —(OC_{d}H_{2d})— may also be present, i.e, not only structural units of the formula —(C₂H₄O)—, but also structural units of the formula —(C₃H₆O)—.

The adjuvants (IIa) to (IIf) will usually be surface-active substances.

In a further preferred embodiment of the invention, the weight ratio of the one or more quaternary ammonium compounds of the formula (I) to the one or more further adjuvants (II) in the compositions according to the invention is from 95 to 5 up to 5 to 95 and preferably from 80 to 20 up to 20 to 80.

In a further preferred embodiment of the invention, the compositions according to the invention are present as concentrated formulations which are diluted prior to use, in particular with water (for example “ready-to-use”, “in-can” or “built-in” formulations) and comprise the one or more water-soluble pesticides of component a) in amounts of from 5 to 80% by weight, preferably from 10 to 70% by weight and particularly preferably from 20 to 60% by weight and the one or more quaternary ammonium compounds of the formula (I) in amounts of from 1 to 25% by weight, preferably from 2 to 20% by weight and particularly preferably from 3 to 15% by weight. These quantities are based on the entire concentrate formulation, and, in the case of pesticides which are employed in the form of their water-soluble salts, on the amount of free acid, known as the “acid equivalent” (a.e.).

Preferably, the compositions according to the invention are applied to the fields in the form of spray mixtures. In this context, the spray mixtures are prepared by diluting concentrated formulations with a defined amount of water.

In a further preferred embodiment of the invention, the compositions according to the invention are present as spray mixtures and comprise from 0.001 to 10% by weight, preferably from 0.02 to 3% by weight and particularly preferably from 0.025 to 2% by weight of the one or more water-soluble pesticides of component a) and from 0.001 to 3% by weight, preferably from 0.005 to 1% by weight and particularly preferably from 0.01 to 0.5% by weight of the one or more quaternary ammonium compounds of the formula (I), The quantities stated are based on the entire spray mixture, and, in the case of pesticides which are employed in the form of their water-soluble salts. on the amount of free acid, known as the “acid equivalent” (a.e.),

The invention furthermore relates to the use of the compositions according to the invention for controlling and/or combating weeds, fungal diseases or insect attack. Preferred is the use of the compositions according to the invention for controlling and/or combating weeds.

These uses may preferably also take place by what is known as the tank-mix method. Here, the one or more water-soluble pesticides of component a) and the one or more quaternary ammonium compounds of the formula (I) and also the water may also be present in the form of what is known as a “tank mix” preparation, in such a preparation, not only the one or more water-soluble pesticides, but also the one or more quaternary ammonium compounds of the formula (I), the latter optionally together with further adjuvants, are present separately from one another. Before application, as a rule briefly before application, these two compositions are mixed with each other, giving rise to a composition according to the invention.

### EXAMPLES

The invention is hereinbelow illustrated with reference to examples, which, however, should not be considered to be limiting.

Various compositions according to the invention (see table 1) are prepared from a commercially available aqueous solution of glyphosate-isopropylammonium (IPA), 62% by weight, or glyphosate-potassium (K), 58% by weight, adjuvant 1 and water. The resulting compositions E1, E2 and E3 comprise 360, 480 and 540 g/l glyphosate a.e. (a.e. acid equivalent).

The cloud point, the viscosity and the foam behavior of the preparations prepared in this manner are determined by CIPAC method MT 47,1 (“Persistant Foam”). The results are shown in table 1.

TABLE 1
Results on the study of glyphosate compositions
according to the invention

| | | E1 | E2 | E3 |
|---|---|---|---|---|
| Composition | | (360 g/l a.e.) | (480 g/l a.e.) | (540 g/l a.e.) |
| Glyphosate- | [g] | 48.6 | 55.8 | — |
| IPA salt | | | | |
| Glyphosate- | [g] | — | — | 66.1 |
| K salt | | | | |
| Adjuvant 1 | [g] | 6 | 6 | 6 |
| Water | [g] | 62.4 | 59.2 | 62.9 |
| Cloud point | [° C.] | >95 | >95 | >95 |
| Viscosity at | [mPa · s] | 25 | 115 | 30 |
| 25° C. | | | | |
| Foam | [ml] | 0 | 0 | 0 |

Adjuvant 1 = C_{8/10}-alkyldimethyl(hydroxyethyl)ammonium chloride of the formula (I)

The comparative examples used are analogously prepared compositions C1, C2 and C3, which, however, comprise adjuvant 2 and are therefore not Inventive. The respective results of the study are shown in table 2.

TABLE 2
Results of the study of non-inventive glyphosate compositions

| | | C1 | C2 | C3 |
|---|---|---|---|---|
| Composition | | (360 g/l a.e.) | (480 g/l a.e.) | (540 g/l a.e.) |
| Glyphosate- | [g] | 48.6 | 55.8 | — |
| IPA salt | | | | |
| Glyphosate- | [g] | — | — | 66.1 |
| K salt | | | | |
| Adjuvant 2 | [g] | 6 | 6 | 6 |
| Water | [g] | 62.4 | 59.2 | 62.9 |
| Cloud point | [° C.] | >95 | >95 | >95 |
| Viscosity at | [mPa · s] | 35 | 125 | 30 |
| 25° C. | | | | |
| Foam | [ml] | >150 | >150 | >150 |

Adjuvant 2 = C_{12/14}-alkyldimethyl(hydroxyethyl)ammonium chloride

Compositions E1 to E3 according to the invention, which are based on a quaternary ammonium compound with a C_{8/10}-alkyl chain, do not demonstrate any foam development while the non-inventive comparative compositions, which are based on a quaternary ammonium compound with a C_{12/14}-alkyl chain, demonstrate a large amount of persistent foam.

We claim:

1. A composition comprising
a) one or more water-soluble pesticides,
b) one or more quaternary ammonium compounds of the formula (I)
R¹R²R³N⁺—(CₘH₂ₘO)ₚH X⁻ (I)
wherein
R¹ is a linear or branched alkyl group having 6 to 10 carbon atoms,
R² and R³ may be identical or different and in each case independently of one another are an alkyl group having 1 to 3 carbon atoms,
m is 2 or 3,
p is a number from 1 to 5 and
X is chlorine, and
c) water.

2. The composition as claimed in claim 1, wherein the one or more water-soluble pesticides of component a) are selected from the group of the herbicides, preferably from among the water-soluble salts of 2,4-D, bentazone, dicamba, fomesafen, glyphosate, glufosinate, MCPA and paraquat, and particularly preferably from among the water-soluble salts of glyphosate.

3. The composition as claimed in claim 1 or 2, wherein, in the one or more quaternary ammonium compounds of the formula (I),
R¹ is a linear or branched alkyl group having 8 to 10 carbon atoms,
R² and R³ are identical and are in each case a methyl or ethyl group,
m is 2 or 3,
p is 1 or 2 and
X is chlorine.

4. The composition as claimed in one or more of claims 1 to 3, wherein, in the one or more quaternary ammonium compounds of the formula (I),
R^{l} is a linear or branched alkyl group having 8 to 10 carbon atoms,
R² and R³ are identical and are in each case a methyl group,
m is 2,
p is 1 and
X is chlorine.

5. The composition as claimed in one or more of claims 1 to 4, wherein, in the one or more quaternary ammonium compounds of the formula (I),
R¹ is a linear or branched alkyl group having 8 carbon atoms,
R² and R³ are identical and are in each case a methyl group,
m is 2,
p is 1 and
X is chlorine.

6. The composition as claimed in one or more of claims 1 to 4, wherein, in the one or more quaternary ammonium compounds of the formula (I),
R¹ is a linear or branched alkyl group having 10 carbon atoms,
R² and R³ are identical and are in each case a methyl group,
m is 2,
p is 1 and
X is chlorine.

7. The composition as claimed in one or more of claims 1 to 6, wherein the amount of the one or more water-soluble pesticides of component a) in the composition is from 80 to 800 g/l, preferably from 200 to 700 g/l and particularly preferably from 300 to 650 g/l.

8. The composition as claimed in one or more of claims 1 to 7, wherein the amount of the one or more quaternary ammonium compounds of the formula (I) in the composition is from 20 to 250 g/l, preferably from 40 to 200 g/l and particularly preferably from 50 to 150 g/l.

9. The composition as claimed in one or more of claims 1 to 8, which has a cloud point of greater than 55° C., preferably of greater than 70° C. and particularly preferably of greater than 80° C.

10. The composition as claimed in one or more of claims 1 to 9, which comprises, besides the one or more quaternary ammonium compounds of the formula (I), one or more further adjuvants (II).

11. The composition as claimed in claim 10, wherein the one or more adjuvants (II) are selected from the group consisting of:
(IIa) one or more fatty amine ethoxylates of the formula (IIa) 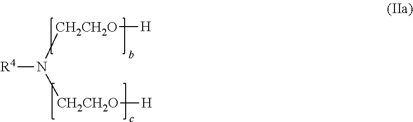
wherein
R⁴ is a linear or branched, saturated or unsaturated hydrocarbon group, having 8 to 22 carbon atoms, and
b and c in each case independently of one another are numbers from 1 to 10,
(IIb) one or more ether amine ethoxylates of the formula (IIb) 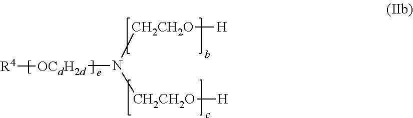
wherein
R⁴ is a linear or branched, saturated or unsaturated hydrocarbon group, having 8 to 22 carbon atoms,
d is 2 or 3,
e is a number from 1 to 5 and
b and c in each case independently of one another are numbers from 1 to 10,
(IIc) one or more betaines, amidoalkylbetaines of the formula (IIc)
R⁴—[CONH—(CH₂)ₙ]ₐN⁺R⁵R⁶—CH₂—COO⁻ (IIc)
wherein
R⁴ is a linear or branched, saturated or unsaturated hydrocarbon group, preferably an alkyl group, having 8 to 22 carbon atoms,
R⁵ and
R⁶ in each case independently of one another are a methyl or ethyl group,
n is a number from 1 to 5 and
a is 0 or 1,
(IId) one or more amine oxides, amidoalkylamine oxides of the formula (IId)
R⁴—[CONH—(CH₂)ₙ]ₐN⁺R⁵R⁶—O⁻ (IId)
wherein
R⁴ is a linear or branched, saturated or unsaturated hydrocarbon group, preferably an alkyl group, having 8 to 22 carbon atoms,
R⁵ and
R⁶ in each case independently of one another are a methyl or ethyl group,
n is a number from 1 to 5 and
a is 0 or 1,
(II) one or more polyglycosides of the formula (IIe) 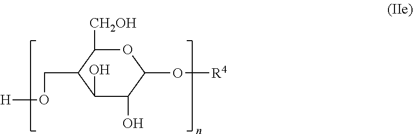
wherein
R⁴ is a linear or branched, saturated or unsaturated hydrocarbon group, having 8 to 22 carbon atoms, and
h is a number from 1 to 5, and
(IIf) one or more copolymers (IIf), which are obtainable copolymerization of
i) glycerol,
ii) one or more dicarboxylic acids and
iii) one or more monocarboxylic acids R⁷—COOH, wherein R⁷ is (C₅-C₂₉)-alkyl, (C₇-C₂₉)-alkenyl, phenyl or naphthyl, and which comprise 19.9 to 99% by weight of component i), 0.1 to 30% by weight of component ii) and 0.9 to 80% by weight of component iii).

12. The composition as claimed in claim 10 or 11, wherein the weight ratio of the one or more quaternary ammonium compounds of the formula (I) to the one or more further adjuvants (II) is from 95 to 5 up to 5 to 95 and preferably from 80 to 20 up to 20 to 80.

13. The composition as claimed in one or more of claims 1 to 12, which is present as a concentrate formulation which is diluted before use and which comprises from 5 to 80% by weight, preferably from 10 to 70% by weight and particularly preferably from 20 to 60% by weight of the one or more water-soluble pesticides of component a) and from 1 to 25% by weight, preferably from 2 to 20% by weight and particularly preferably from 3 to 15% by weight of the one or more quaternary ammonium compounds of the formula (I).

14. The composition as claimed in one or more of claims 1 to 12, which is present as a spray mixture and which comprises from 0.001 to 10% by weight, preferably from 0.02 to 3% by weight and particularly preferably from 0.025 to 2% by weight of the one or more water-soluble pesticides of component a) and from 0.001 to 3% by weight, preferably from 0.005 to 1% by weight and especially preferably from 0.01 to 0.5% by weight of the one or more quaternary ammonium compounds of the formula (I).

15. The use of a composition as claimed in one or more of claims 1 to 14 for controlling and/or combating weeds, fungal diseases or insect attack, preferably for controlling and/or combating weeds.

16. The use as claimed in claim 15 by the tank-mix method.
